(19) United States
(12) Patent Application Publication
(10) Pub. No.: US 2005/0152135 A1
(43) Pub. Date: Jul. 14, 2005

(54) Portable reading lamp

(76) Inventor: Jianping Cai, Shunde (CN)

Correspondence Address: MERCHANT & GOULD PC, P.O. BOX 2903, MINNEAPOLIS, MN, 55402-0903, US

(21) Appl. No.: 11/034,574

(22) Filed: Jan. 13, 2005

(30) Foreign Application Priority Data
Jan. 13, 2004 (CN) 2004200146503

(51) Int. Cl. F21V 9/10

(52) U.S. Cl. 362/167

(57) ABSTRACT

A portable reading lamp of the invention comprises a base, a head portion and a beanpole to connect the base with the head portion. The head portion is provided with the luminant, which is semiconductor LED. A battery box is provided on the base, the head portion or the beanpole for supplying direct current. The semiconductor LED is used as the luminant in the invention, so the reading lamp of the invention can save energy in high-efficiency (10% electricity consumption of the traditional reading lamp), which also has the following strongpoint: saturated color and ray, infinite motley, switching rapidly, unpolluted, shock-resistant, dampness-resistant, long usage life (100,000 hours), radiation-free and less maintenance. The invention also provides a battery box in the base for supplying direct current, which is very convenient to be used in the field when no external power source can be used.

### FIELD OF THE INVENTION

The present invention is related to a head lamp, and more particularly to a portable reading lamp.

### BACKGROUND OF THE INVENTION

At present, there are many kinds of reading lamps, each of which is mainly consisted of a base, a head portion and a beanpole connecting the base with the head portion. On the head portion there is an illuminant mounted which can be an incandescent bulb, a solar bulb or the like. However, the traditional reading lamps are all applied to alternative voltage so that it is discommodious to be taken. In addition, frequency flash can frequently occur to the lamps during usage so as to hurt user's eyes. Also, the incandescent bulb and the fluorescent lamp have the disadvantage of short usage life, frangibility, low luminance, glaring, large electricity consumption, etc. Moreover, the beanpole of the traditional reading lamp is a kind of flectional soft-tube structure in order to change the angle and position of the head portion relative to the beanpole and the base. Notwithstanding the head portion and the beanpole can change their angle and be bent, the head portion, the beanpole and the base cannot be tightly combined together (such as folding), Thus a larger space will be occupied during transportation and schlepping which results in much inconvenience.

Hence it is desired to provide a portable reading lamp which can overcome the foregoing drawbacks of the prior art.

### SUMMARY OF THE INVENTION

A main object of the present invention is to provide a portable reading lamp having an long usage-life illuminant and without the problem of frequency flash.

To achieve the above-mentioned object, a portable reading lamp of the invention comprises a base, a head portion and a beanpole to connect the base with the head portion. The head portion is provided with the luminant, which is semiconductor light-emitting diode. A battery box is provided on the base, the head portion or the beanpole for supplying direct current.

In an embodiment, the head portion further comprises a motherboard and a cover, a plurality of holes provided on the motherboard arrayed in a certain manner, the semiconductor light-emitting diodes are parallel connection to a circuit board electrically, which are embedded in the holes respectively. In an embodiment, the hole is a subulate hole. The base is provided at one end with a switch means for adjusting amount of semiconductor light-emitting diodes.

In another embodiment, the base is provided at one end with a charger jack. The base is provided at one end with a charge indicator light and a discharge indicator light. The head portion and the beanpole are connected by a first turning structure. The base and the beanpole are connected by a first turning structure.

In a further embodiment of the present invention, the first turning structure comprises a threaded turning shaft with two through holes which connected with the head portion; two bolts connected with the beanpole; wherein the threaded turning shaft is connected with the head portion through a friction patch, a dishing spring, a lock washer and a screw cap hitched thereon; one of the bolt is connected with the threaded turning shaft through a friction patch, a dishing spring, a lock cushion and a screw cap hitched thereon; the other bolt is connected with the threaded turning shaft through the block spring hitched thereon.

In an embodiment of the present invention, the second turning structure comprises a threaded turning shaft and a base turning shaft both connected with the base; wherein the threaded turning shaft is connected with the beanpole through a lock patch hitched thereon; the base turning shaft is connected with the beanpole through a lock patch, a dishing spring and a screw cap hitched thereon. In another embodiment, the beanpole is a telescopic pole, which may be consisted of at least two sleeves with different sizes assembled together. In a further embodiment, a beanpole slot is provided in the top of the base for receiving the beanpole.

Compared with the prior art, the semiconductor LED is used as the ruminant in the invention, so the reading lamp of the invention can save energy in high-efficiency (10% electricity consumption of the traditional reading lamp), which also has the following strongpoint: saturated color and ray, infinite motley, switching rapidly, unpolluted, shock-resistant, dampness-resistant, long usage life (100,000 hours), radiation-free and less maintenance. The invention also provides a battery box in the base for supplying direct current, which is very convenient to be used in the field when no external power source can be used. The turning structure connection between the head portion and the beanpole, and also between the base and the beanpole will make the head portion change its angle relative to the beanpole, and also make the beanpole change its angle and distance relative to the base. A telescopic pole used as the beanpole and a beanpole slot provided in top of the base for receiving the beanpole will make the head portion, the beanpole and the base can be combined together tightly so that the reading lamp is convenient to be transported or taken, even used as a electric torch.

For the purpose of making the invention easier to understand, one particular embodiment thereof will now be described with reference to the appended drawings in which:

### DESCRIPTION OF THE DRAWINGS

FIG. 1 is a view to show a reading lamp of the invention in an open status;

FIG. 2 is a view to show a reading lamp of the invention in a folded status;

FIG. 3 is an exploded view of a head portion and a first turning structure of the reading lamp of FIG. 1;

FIG. 4 is an exploded view of a beanpole of the reading lamp of FIG. 1;

FIG. 5 is an exploded view of a base and a first turning structure of the reading lamp of FIG. 1;

FIG. 6 is an exploded view of a battery box in the base of the reading lamp of FIG. 1; and

FIG. 7 is a view to show a work principle of the reading lamp of FIG. 1.

### DETAILED DESCRIPTION OF TiE INVENTION

Referring now to the drawing in detail, as shown in FIG. 1, according to an embodiment of the present invention, a portable reading lamp is consisted of a base D, a head portion A and a beanpole B to connect the base D with the head portion A. The head portion A and the beanpole B are jointed through a first turning structure C, while the base D and the beanpole B are jointed through a second turning structure E.

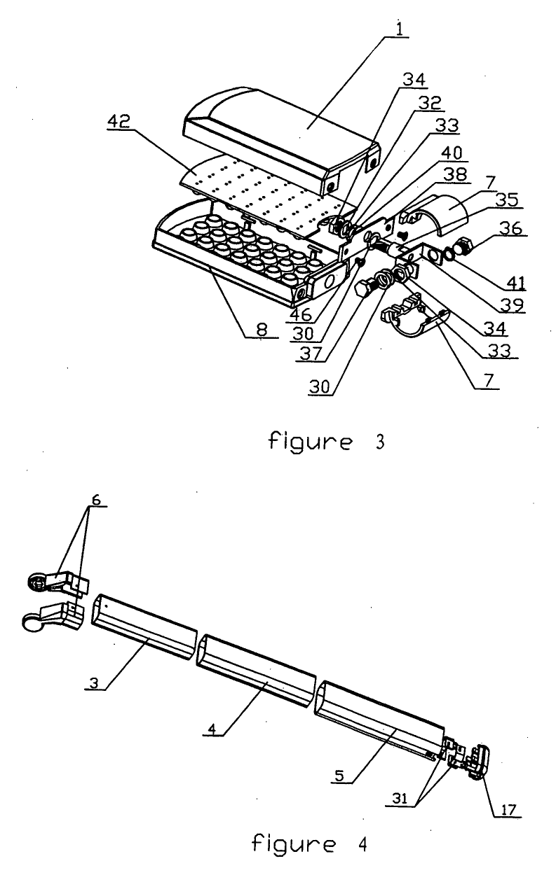

Referring to FIG. 3, the head portion A is consisted of a cover 1, a circuit board 42 (including twenty eight semiconductor LEDs connected on the circuit board, which are arrayed as seven rows and four columns) and a motherboard 8. The motherboard 8 is provided with twenty eight subulate holes corresponding to the twenty eight semiconductor LEDs. During assembling, the semiconductor LEDs are embedded in the subulate holes, respectively. The first turning structure C is consisted of a screw turning shaft 35 two bolts 36, 37. The screw turning shaft 35 has a stator 39 on its tail. Two through holes are respectively formed in both sides of the stator 39, the bolt 37 traverses the through hole of one side of the stator 39 from outside to inside, and then a friction patch 30a, a dishing spring 33a and a bolt 34 are hitched and tweaked tightly on the tail of the bolt 37 in sequence. Similarly, the bolt 36 traverses the through hole of the other side of the stator 39, and the block spring 41 is hitched and stuck on the tail of the bolt 37, then, a friction patch 30b a stator 38 on the end of the head portion a wedge 40, a dishing spring 33b, a fixed patch 32a and a screw cap 34 are hitched and tweaked tightly on the head portion of the screw turning shaft 35 in sequence. The stator 38 is fixed on the head portion A through a screw 46, upper and lower covers 7 of the turning structure C for enclosing the turning structure C, thus making the appearance thereof more fluent and pleasing.

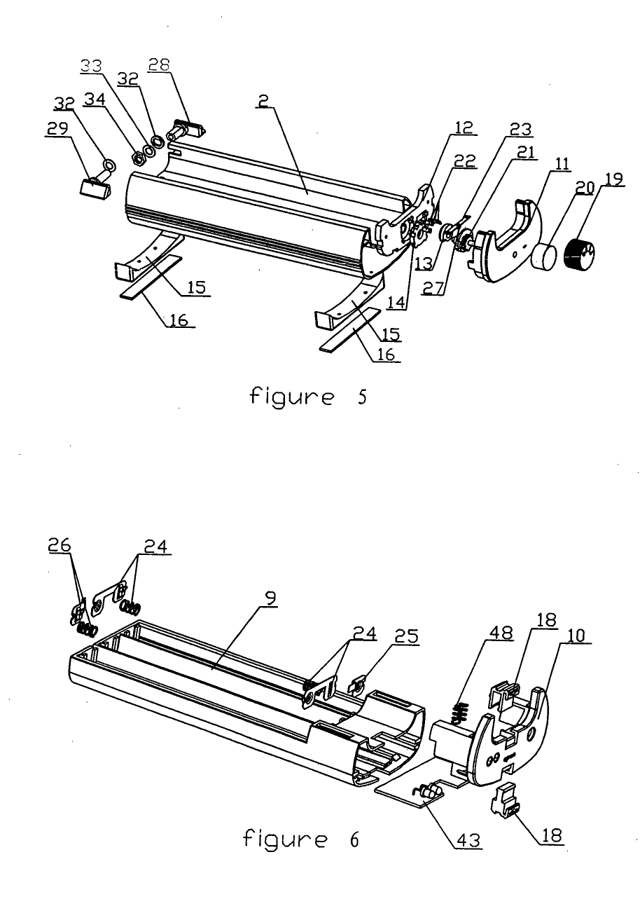

Referring to FIG. 4, the beanpole B is consisted of upper-pole plugs (left, right) 6, an upper pole 3, a middle pole 4, a lower pole 5, two stators 31 and a lower-pole plug 17. The upper pole 3, the middle pole 4 and the lower pole 5 are hitched together to form a telescopic beanpole. The upper-pole plugs 6 is blocked in the upper pole 3, and the two bolts 36, 37 of the turning structure C are embedded in the upper-pole plugs 6 (left, right) so as to connect the head portion A with the beanpole B through the turning structure C. The head portion A can rotate in a range of three hundred and thirty degrees around the axis of the screw turning shaft 35, which can also be fixed in a certain angle by the dishing spring 33b. In addition, the head portion A and the turning structure C can also rotate around the axis of two bolts 36, 37 in a large angle. Similarly, the head portion A and the turning structure C can be fixed at a certain angle by the dishing spring 33a.

Referring to FIG. 5, the second turning structure E is consisted of a base turning shaft 28 and a thread turning shaft 29. A screw cap 34, a dishing spring 33c, a fixed patch 32b and a stator 31 are hitched and tweaked on the base turning shaft 28 in sequence. The fixed patch 32c and another stator 31 are sequently hitched on the thread turning shaft 29. The base turning shaft 28 and the thread turning shaft 29 are embedded in the front end of the base D, respectively. Thus the beanpole B is connected with the base D by the turning structure E, and the beanpole B can rotate around the axis of the base turning shaft 28 and the thread turning shaft 29 in a large angle. The beanpole B can be fixed in a certain angle by the dishing spring 33c. The bottom surface of the base D is provided with fixed feet 15 on its front and rear end. Each of the fixed feet 15 is provided a fixed cushion 16 on its lower portion. A beanpole slot 2 is formed in the top of the base D for receiving the beanpole B. An end cover 11 is hitched at the back end of the base D. In the front of the end cover 11 and inside the base D there is a switch board 12. A switch fixed block 14, a semi-shaft 13 and a switch turning shaft 21 are provided between the end cover 11 and the switch board 12 in sequence. A switch copper sheet 22 is provided on the fixed block 14, and a switch spring plate 23 is placed on the semi-shaft 13. A steel ball 27 is provided on the switch spring plate 23. In addition, there are a knob plug 20 and a switch knob 19 on the end cover 11. The knob plug 20 is connected with the switch turning shaft 21, and the switch knob 19 encloses the knob plug 20.

Referring to FIG. 6, a battery box 9 is provided inside the base D which has a shape matched with the base D. An anode and cathode patch 24, an anode patch 25 and a cathode patch 26 are formed on the end of the battery box 9. Inside the battery box 9 there is also a control board 43 connected with the switch board 12. Two charge indicator lights are provided on the control board 43. There are a button slot and a button spring 48 matched with buttons 18 (upper, lower) on the end cover 10 of the battery box 9. Also, a charge jack is formed on the panel of end cover 10 for charging the charge battery. On the panel also a plurality of light holes are formed for exposing the charge indicator lights and the discharge indicator lights.

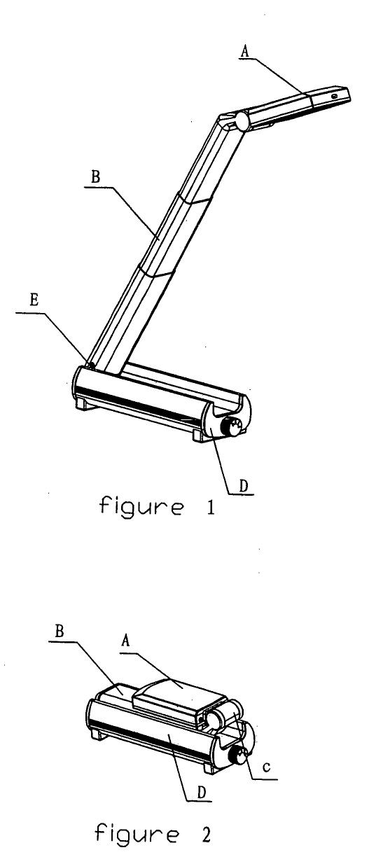

Referring to FIG. 2, the head portion A and the beanpole B can be hidden inside the beanpole slot 2 due to the presence of the turning structure C, E and the telescopic beanpole B. This will greatly reduce the occupation space of the reading lamp and thus it is convenient to be taken.

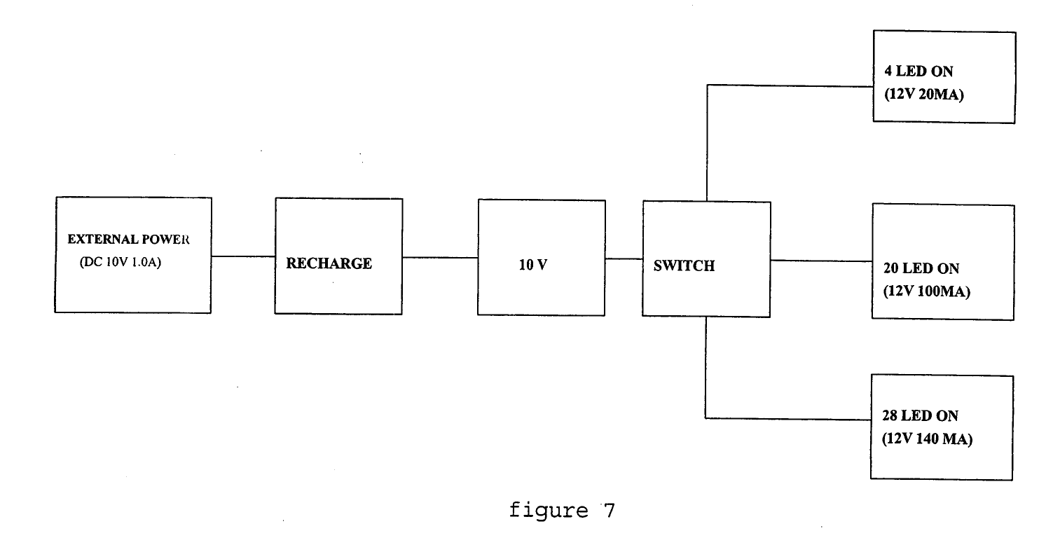

Referring to FIG. 7, the reading lamp of the invention has a work principle as follows: four charge batteries (such as three Volts) inside the battery box are charged by an external power source (such as a direct current power source with ten volts voltage and one ampere current). The voltage will arise to ten volts when finishing charge. At the time, the switch knob 19 is revolved to adjust output position with the help of the switch turning shaft 21, the semi-shaft 13, the switch fixed block 14 and the control board 43. When being adjusted to the position 1, four LEDs (twelve volts, twenty milliamperes) will be switched on; when being adjusted to the position 2, twenty LEDs (twelve volts, one hundred milliamperes) will be switched on; when being adjusted to the position 3, twenty-eight LEDs (twelve volts, one hundred and forty milliamperes) will be switched on.

It is understood that the invention may be embodied in other forms without departing from the spirit thereof. Thus, the present example and embodiment are to be considered in all respects as illustrative and not restrictive, and the invention is not to be limited to the details given herein.

1. A portable reading lamp comprising
a base, a head portion and a beanpole to connect the base with the head portion; wherein the head portion is provided with the luminant;
the luminant being semiconductor light-emitting diode, a battery box provided on the base, the head portion or the beanpole for supplying direct current.

2. The reading lamp as claimed in claim 1, wherein the head portion further comprising a motherboard and a cover, a plurality of holes provided on the motherboard arrayed in a certain manner, the semiconductor light-emitting diodes are parallel connection to a circuit board electrically, which are embedded in the holes respectively.

3. The reading lamp as claimed in claim 2, wherein the base is provided at one end with a switch means for adjusting amount of semiconductor light-emitting diodes.

4. The reading lamp as claimed in claim 1, wherein the base is provided at one end with a charger jack.

5. The reading lamp as claimed in claim 4, wherein the base is provided at one end with a charge indicator light and a discharge indicator light.

6. The reading lamp as claimed in claim 1, wherein the head portion and the beanpole are connected by a first turning structure.

7. The reading lamp as claimed in claim 1, wherein the base and the beanpole are connected by a first turning structure.

8. The reading lamp as claimed in claim 6, wherein the first turning structure comprising:
a threaded turning shaft with two through holes which connected with the head portion;
two bolts connected with the beanpole;
wherein the threaded turning shaft is connected with the head portion through a friction patch, a dishing spring, a lock washer and a screw cap hitched thereon;
one of the bolt is connected with the threaded turning shaft through a friction patch, a dishing spring, a lock cushion and a screw cap hitched thereon;
the other bolt is connected with the threaded turning shaft through the block spring hitched thereon.

9. The reading lamp as claimed in claim 7, wherein the second turning structure comprising:
a threaded turning shaft and a base turning shaft both connected with the base; wherein the threaded turning shaft is connected with the beanpole through a lock patch hitched thereon; the base turning shaft is connected with the beanpole through a lock patch, a dishing spring and a screw cap hitched thereon.

10. The reading lamp as claimed in claim 1, wherein the beanpole is a telescopic pole.

11. The reading lamp as claimed in claim 1, wherein the telescopic beanpole is consisted of at least two sleeves with different sizes assembled together.

12. The reading lamp as claimed in claim 10, wherein a beanpole slot is provided in the top of the base for receiving the beanpole.

13. The reading lamp as claimed in claim 2, wherein the hole is a subulate hole.
